(19) United States
(12) Patent Application Publication
(10) Pub. No.: US 2014/0187218 A1
(43) Pub. Date: Jul. 3, 2014

(54) MANAGING GROUP CALLING FROM A WIRELESS MOBILE APPLICATION

(71) Applicant: Stanacard LLC, New York, NY (US)

(72) Inventors: Manlio Carrelli, New York, NY (US); Michelle Ryan, Copiague, NY (US); Drew Bernstein, North Caldwell, NJ (US); Koray Kilic, Brooklyn, NY (US); Michael Khomenkov, Plainsboro, NJ (US)

(73) Assignee: Stanacard LLC, New York, NY (US)

(21) Appl. No.: 13/896,080

(22) Filed: May 16, 2013

Related U.S. Application Data
(60) Provisional application No. 61/648,509, filed on May 17, 2012.

(51) Int. Cl. H04W 4/16

(52) U.S. Cl. CPC H04W 4/16
USPC 455/416

(57) ABSTRACT

A method and system for managing group calling from a wireless mobile application is provided. One or more wireless mobile devices are provided that access a wireless network. At least one user can create at least one group call using one of the mobile devices using swipe gestures to create groups from a user's contact list and establishing the at least one group call over the wireless network.

### FIELD

This invention relates to a swipe-and-add feature of wireless mobile devices and in particular to managing audio and video calls for group of participants using such mobile devices.

### BACKGROUND

It is known to conduct multiple-participant conferences via mobile applications, including but not limited to audio and video conferencing over a mobile platform. A “mobile platform” can include a mobile operating system that controls smartphone, tablet, PDA or other mobile device and cooperates with features such as touchscreens, Bluetooth, WiFi, GPS, cameras, video, speech recognition, near-field communication (NFC) and complementary and equivalent features. Such cooperation has enabled users to conduct interactive group activities over social and business networks. Such activities include teleconference calls and “virtual” meetings conducted online or via community telepresence technology.

With half of U.S. mobile consumers owning smartphones (and with smartphones comprising only a portion of mobile devices), continuing overlap among multiple personal and work lives is inevitable. The advent of media-rich technologies on mobile devices enable sense of liberation for users of such devices, yet such users continue to face inherent problems when confronted with actual or virtual “presence” at group discussions. When geographically dispersed participants need to collaborate, communication among them should replicate real-time communication expected if the participants are physically in the same location. Similarly, even co-located participants may have competing interests requiring communication tailored to the then-current situation and appropriate for some participants but not others.

Additional difficulty is introduced by the social expectation for all such communications to be executed in a manner similar to that in which other mobile applications are used to ensure a consistent understanding among users. For instance, it is useful for different applications to have visually appealing and intuitive functions that not only bridge the gap between known and unknown applications but also prompt the desire to engage in group communications in a familiar manner. To date, however, group calls have confused business people and consumers because such communications are not constructed intuitively using understood concepts (for example, reconciling concepts of group interactivity and communication with a focus on connecting individual communication lines for each user.

The presently disclosed invention now provides such solutions and provides other advantages that are understood from the present disclosure.

### SUMMARY

In accordance with the principles of the presently disclosed invention, a method is provided for managing group calling from a wireless mobile application. Such a method may include providing one or more wireless mobile devices that access a wireless network; enabling at least one user to create at least one group call using one of the mobile devices; using swipe gestures to create groups from a user's contact list; and establishing the at least one group call over the wireless network. The swipe gestures can include one or more of finger gestures, optical gestures, voice commands and equivalents and combinations thereof. A network interface performs at least one of communicating with other mobile devices over the network; creating a group list from a contact list, with the group list including one or more participants from the contact list and with each participant having an associated mobile number; and managing a group call. At least one user uses swipe gestures to create the group list from the contact list, and at least one user uses swipe gestures to manage the group call.

A system for managing group calling from a wireless mobile application is also provided that includes one or more wireless mobile devices that access a wireless network. At least one mobile device includes a network interface for enabling a user to create at least one group call using swipe gestures to create groups from the user's contact list and to establish the at least one group call over the wireless network. The swipe gestures include one or more of finger gestures, optical gestures, voice commands and equivalents and combinations thereof. The network interface performs at least one of communicating with other mobile devices over the network; creating a group list from a contact list, with the group list including one or more participants from the contact list and with each participant having an associated mobile number; notifying participants of a group call schedule; and managing a group call. The user uses swipe gestures to create the group list from the contact list, and the user uses swipe gestures to manage the group call. Managing the group call includes at least one of moving participants between the contact list and the group list to create at least one call group for the group call; viewing participants in the at least one call group; establishing the group call from the interface to simultaneously call all participants in the group list; and terminating the group call from the interface for at least one participant.

A non-transitory computer-readable medium may be operable on a network-connected computer comprising one or more programs for carrying out a method for managing group calling from a wireless mobile application. The medium can be distributed or located in different devices or located in a single device, with the devices not limited to mobile devices.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 shows an exemplary schematic representation of a group call.

FIGS. 2 to 5 show exemplary interfaces for managing group calling from a wireless mobile application.

### DETAILED DESCRIPTION OF THE INVENTION

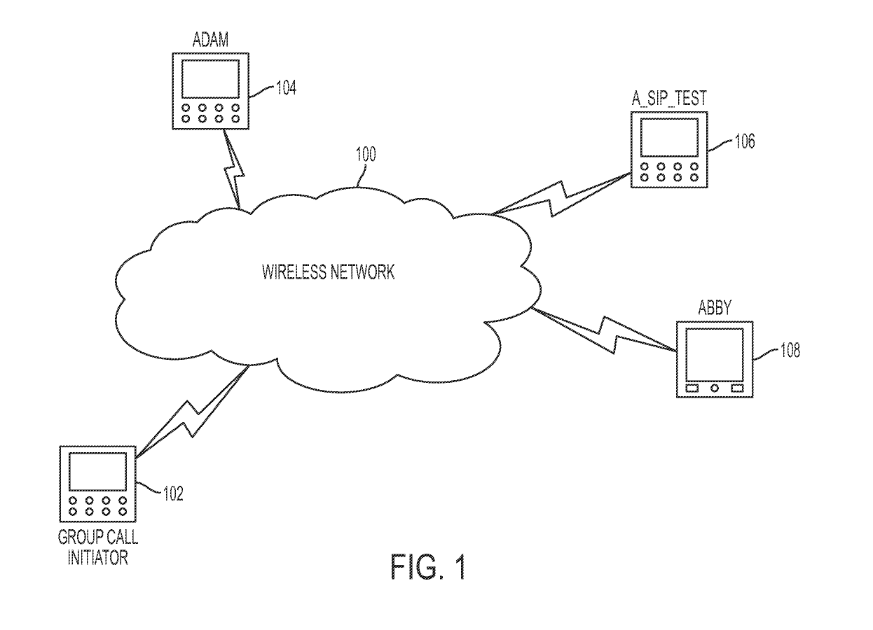

Now referring to the figures, wherein like numbers represent like elements, FIG. 1 is an exemplary schematic representation of managing group calls from an application on one or more wireless mobile devices that access a wireless network 100. Wireless network may comprise one or more networks having one or more wireless mobile devices 102, 104, 106 and 108 in electronic communication therewith. Mobile devices 102, 104, 106 and 108 include interfaces for communicating with one another, as further described below. As used herein, the terms “wireless mobile devices”, “mobile devices” and “wireless devices” may be used interchangeably, in the singular or plural, to refer to smartphones, PDAs, tablets, near-field communication devices, devices with applications implemented at least partly using a cloud service and any other complementary and equivalent devices. It is understood that groups calls may be managed for calls among mobile devices, landlines, other application users and any combination and equivalent thereof.

Mobile device 102 may initiate the group call (see FIG. 1 which shows mobile device 102 being associated in an exemplary manner with a “Group Call Initiator”), and wireless network 100 notifies the identified mobile devices 104, 106 and 108 that a group call has been established. It is understood that the number of mobile devices associated with participants in a group call is not limited to the number of devices shown in FIG. 1. Any number of mobile devices may be incorporated that is commensurate with the number of individuals or groups of individuals participating in a group call. It is also understood that mobile device 102 is not the only mobile device capable of initiating a group call, and that any other mobile device or mobile devices may initiate such group call. It is further understood that different mobile device types, or mobile devices of the same type, may be used in any group call in any combination. For example, mobile device 102 may comprise a smartphone while mobile device 104 comprises a PDA and mobile devices 106 and 108 may comprise tablets. All of the mobile devices, for example, may comprise tablets or all of the mobile devices may comprise smartphones. The composition of groups of mobile device types has no effect on the successful practice of the presently disclosed swipe-and-add feature during group calls.

As used herein, a “group call” includes an audio or visual conference in which multiple individuals or groups of individuals participate in real-time. A “group” can include one or more individuals or can alternatively include one or more other groups, wherein each group includes one or more individuals. Any individual may be included in one or more groups as determined by a group administrator or by an initiator of one or more group calls. In this manner, the group administrator or group call initiator can manage participation in group calls as appropriate (e.g., to control the flow of proprietary information by authorizing pre-identified individuals and/or groups to attend certain group calls and preventing other pre-identified individuals from attending such group calls).

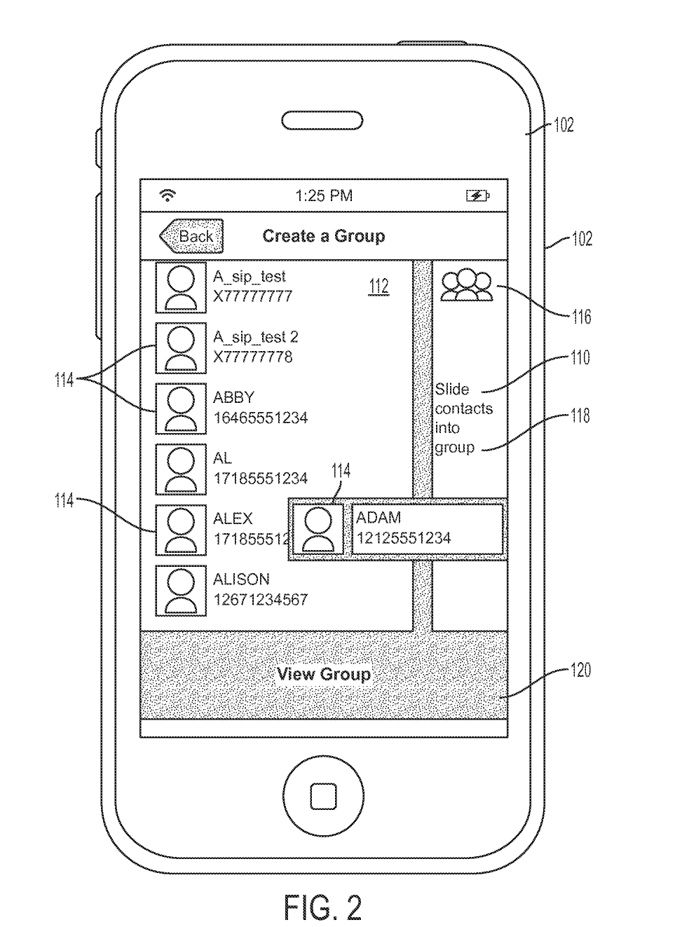

Now referring to FIGS. 2 to 5, an interface 110 for a swipe-and-add feature for a wireless mobile device is provided on mobile device 102. It is understood that the configuration of interface 110 is exemplary and that interface 110 may include alternative and additional functional and aesthetic features. Although reference to interface 110 is made with respect to mobile device 102, it is understood that interface 110 is useful with any mobile device and that any discussion herein with respect to mobile device 102 is made for the exemplary purpose and does not serve to limit any features disclosed herein.

Interface 110 includes a contact list 112 comprising one or more participants 114 each having a mobile number associated therewith. Each participant 114 has an associated button on interface 110 by which a group call initiator may select one or more participants 114 for inclusion in a group call. The group call mimics calls made one at a time to individual participants 114, except that the call is made to all participants 114 at once. Contact list 112 should contain at least two participants 114, although the maximum number of participants is only limited by the performance of the particular wireless network utilized and not by interface 110. Contact list 112 may be stored as a contact (for example, in an “Address Book” or as a “Group”) in wireless mobile device 102 to enable ready access thereto. Each individual participant 114 may be associated with a respective mobile device. FIG. 1 shows an example of this correspondence with mobile device 104 associated with “Adam” and mobile device 108 associated with “Abby”. A group of individuals may also be associated with single or plural mobile devices. FIG. 1 shows an example of this correspondence with mobile device 106 associated with the group “A_Sip_Test”. Group “A_Sip_Test” may, for example, include members of an R&D test group in which the specific individuals in the group may change from time to time but the group itself is ongoing.

From interface 110, the group call initiator creates one or more groups 116 from contact list 112 and includes the group call participants in a group list 118. The group call initiator selects group call participants by selecting identified participants for the group call and swiping the selected participants into group list 118. For example, as shown in FIG. 2, the group call initiator is creating a group in group list 118. The group call initiator has selected participant “Adam” from contact list 112 and swipes the “Adam” button from contact list 112 to group list 118. While “Adam” may be represented by a button as shown in FIG. 2, “Adam” and any other participant 114 may be represented by a name, icon, avatar or other indicia representative of “Adam” and Adam's mobile number.

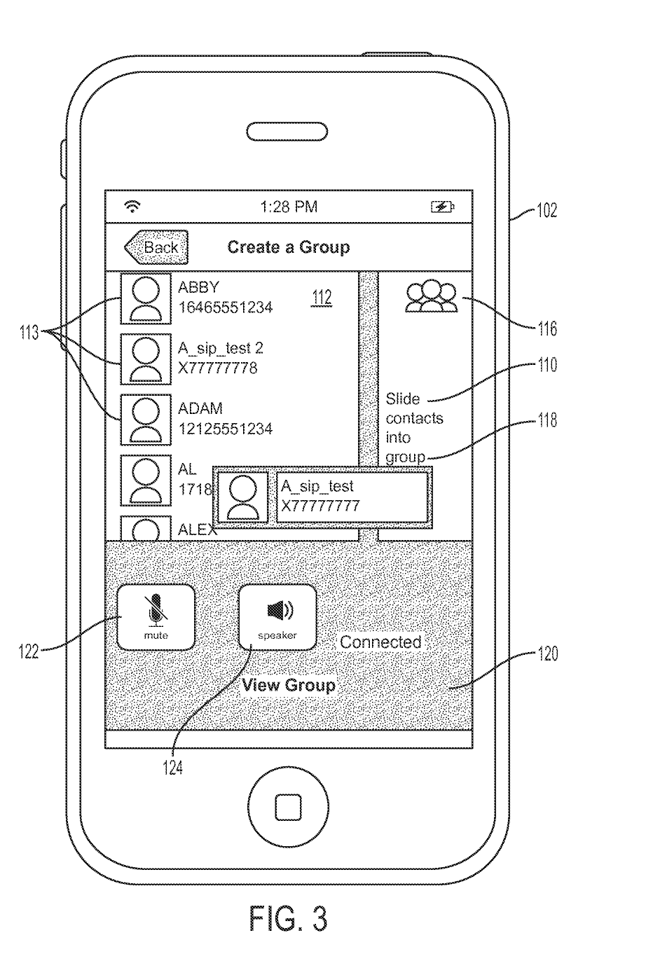

“Adam” is now a member of the group list for which a group call can be made (the “call group”), such that when the group call initiator establishes the group call, Adam will be called along with all other participants who are selected as members of the group list. It is understood that “Adam” and/or any other participants may be saved into group list 118 as members of one or more particular groups. The groups may thereafter be saved as individual groups in contact list 112. For example, such saved groupings enable the group call initiator to select the “Adam” group from the contact list for a subsequent group call. It is not necessary however, to pre-define any groups prior to initiation of the group call, thereby enabling users to spontaneously conduct group calls as warranted (for example, to plan an impromptu family event or to discuss an urgent business transaction). As seen in FIGS. 2 and 3, interface 110 permits the group call initiator to view the participants selected for the call group at any time prior to the group call, for instance by accessing a “View Group” button 120.

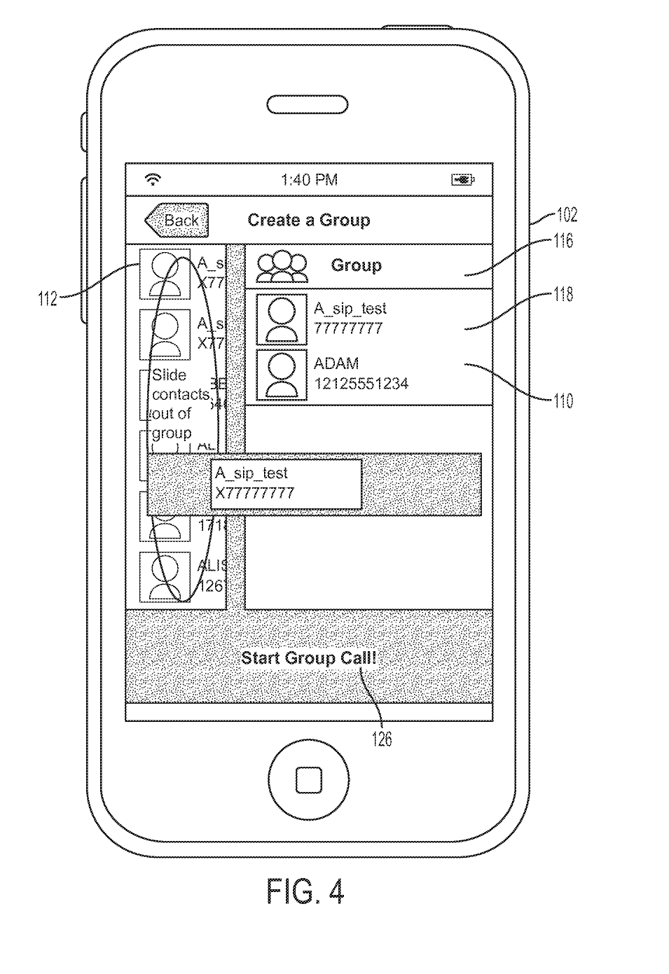

Referring further to FIGS. 3 and 4, interface 110 enables the group call initiator to select additional participants 114 for a group call by swiping participants from contact list 112 to group list 118. Similarly, the group call initiator can remove previously selected participants 114 from group list 118 prior to the group call by swiping the participant button from the group list to the contact list. An example of this is shown in FIG. 3, where the group call initiator has selected “A_Sip_Test” for participation in the group call by swiping the “A_Sip_Test” button from contact list 112 to group list 118. The group call initiator has additionally removed “Adam” from the group list by swiping the “Adam” button from the group list to the contact list. As shown in FIG. 3, interface 110 may include control buttons such as mute button 122 and speaker button 124 that enable control of audio qualities delivered over the mobile device during the group call. Referring further to FIG. 4, the group call initiator has swiped the “Adam” and “A_Sip_Test” buttons into group list to select these participants from contact list 112. Interface 110 permits the group call initiator to call all selected participants in group list 118 at one time, for instance by accessing a “Start Group Call” button 126.

“Swiping” of participants between contact list 112 into group list 118 may be effected, for instance, by “swipe finger gestures”, that is, by touching or nearly touching the selected participant and dragging the selected participant button between the contact list and the group list until the required call group is attained (e.g., via sliding, moving, etc.). “Swiping” may also be effected by voice commands, optical commands and any complementary and equivalent swipe gesture technology for selecting and moving participants between the contact list and group list to create the eventual group that will participate in the group call. The application therefore creates a table view of new call groups to associate swipe gesture technology to the construction of group call lists.

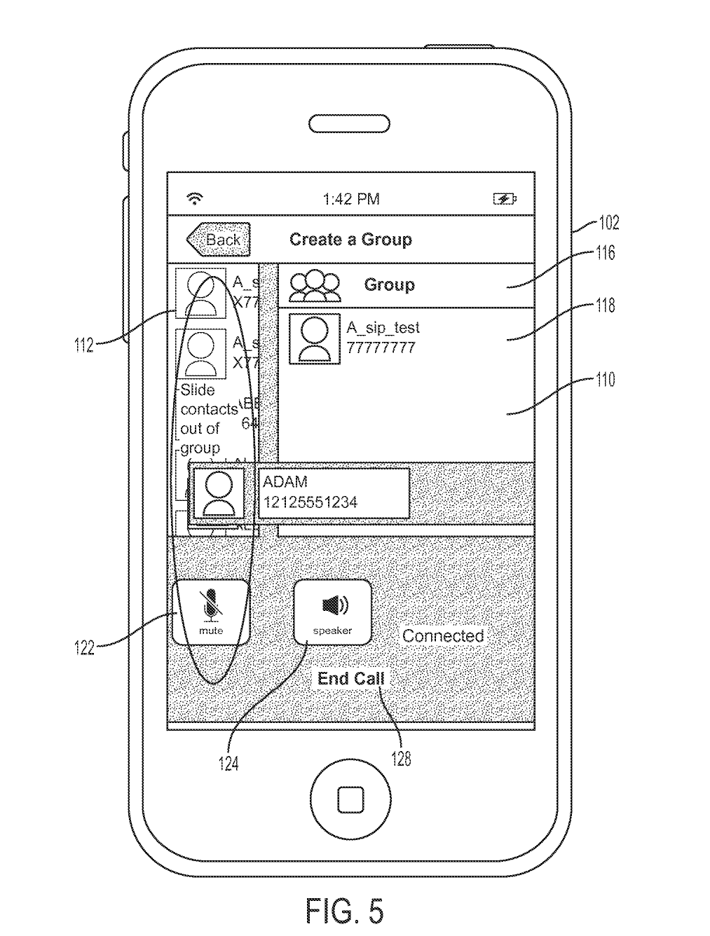

Now referring to FIG. 5, a group call has been initiated to the participants identified in group list 118, namely “Adam” and “A_Sip_Test”. Upon touching the “Start Group Call” button (or using alternative means to start the call, for example, using as a voice command saying “Start Group Call”), the network notifies the identified mobiles 104 and 106 (see FIG. 1) and a call is established by opening a call line on the wireless network. The application passes group list 118 to a server in electrical communication with wireless network 100, and the server creates a conference number for connection of all participants, including the group call initiator, into the open call line. The connection process is automated and hidden from the group call initiator and participants so that the group call appears to be established from the group call initiator's number upon touching the “Start Group Call” button. Wireless network 100 (or one or more components thereof) may be in communication with servers such as VoIP telephony servers that handle telephone calls and services.

For clarity, as used herein, the term “server” includes one or more servers. A server can include one or more computers that manage access to a centralized resource or service in a network. A server can also include at least one program that manages resources (for example, on a multiprocessing operating system where a single computer can execute several programs at once). Further, the terms “computing device”, “computer device”, “computer” and “machine” are understood to be interchangeable terms and shall be taken to include any collection of computing devices that individually or jointly execute a set (or multiple sets) of instructions to perform any one or more of the methods discussed herein.

The server communicates the status of each participant (for example, “dialing participant”, “participant connected”, “participant offline”, etc.) to the application for viewing by the group call initiator. The initiator thereby controls the group call from the application, using swipe gestures to communicate to the server actions such as adding new participants, hanging up on participants, changing audio and visual properties and monitoring call duration (see, for example, FIG. 3 where interface 110 includes a “Connected” indicia, which can include a timer to show the group call initiator the duration of a single group call and/or the duration of multiple group calls over time). As shown in FIG. 5, the group call initiator has selected “Adam” to be removed from group list 118, thereby notifying the server that “Adam” should be dropped from the group call. A group call can be ended at any time by accessing a termination feature such as “End Call” button 128 shown in FIG. 5. Upon touching the “End Call” button, the server is notified that all participants of the call group should be disconnected, thereby eliminating the need for the group call initiator to notify each participant to hang up and also obviating the need for each participant to individually terminate his/her own connection.

Interface 110 can also include a tool for automatically sending a text, email, SMS, voice mail or other message to the call participants for a future date. Such a tool can automatically execute the call at a later scheduled date and time. Such times can be scheduled once or may be reoccurring (for example, a weekly team meeting can be established for the same day and time each week incorporating members of the same group as identified in group list 118 and saved to contact list 112). Such a tool also contemplates automatic insertion of scheduled group calls into participants' calendars subject to permissions established by each participant.

Interface 110 may also access an integrated billing platform that allows users (including but not limited to group call initiators) to pay for the group call with credit available from an account that can be funded from the users' respective mobile devices or via alternative payment Options (e.g., by a web or kiosk or local store). The billing platform can include backend systems and components for managing payments for “group calling”. The billing platform understands and approves the group call before it is initiated and monitors consumption throughout the call to prevent overage. The user can increase an account balance at any time, including during a group call (for instance, by touching a “Deposit Credit Now” button on interface 110, not shown), to allow the group call to continue without notifying other call participants that a payment is required. After a group call is completed, the billing platform collects data from the call and makes that data available for user review within the application or alternatively via another interface (e.g., a website or customer portal). Any account balance may be applied to future group calls or alternatively applied to other products and/or services. Billing may be managed through the billing platform to acquire billing totals for a group call including all participants on the group list. The billing platform can further break down consumption attributable to each call participant on an individual basis. Access to the billing platform through interface 110 ensure users always have access to on-demand call time while controlling consumption of minutes (i.e., having predictable communication costs) attributable per participant per each group call.

The presently disclosed method and system for managing group calling from a wireless mobile application enables users to create group calls (e.g., calls during which multiple parties may listen and speak with one another during a common session) using “swipe” gestures (including “swipe” finger gestures) to create groups from a user's contact list and, with a single button, establish the group call over a wireless network. The user can apply the same swipe gestures to manage call participants, thereby the complexity of manually connecting multiple parties to a common communication link (e.g., a telephone conferencing feature) or creating complex dial-in numbers and pass codes for participants. This may all be accomplished by a method and/or for managing group calls with a wireless mobile application and may be executed by instructions included on a non-transitory computer-readable medium.

As described, the exemplary embodiments are particularly useful for mobile devices, but if desired can be applied to other context including, but not limited to, a landline phone or other communications interface. Also, as described, the embodiments are particularly useful for telephony but if desired could be applied to establish other group communications sessions (e.g., SMS, video chat, etc.).

In some embodiments, a group component (e.g., a group lift or group area) is positioned immediately adjacent, or in close proximity to, a contacts component (e.g., a contact list or contact area) and permits a short, quick action to add individuals to the call group from the contact list. As shown, a call option can sit in the same window as one or both of the group component and the contact component, permitting the user to “swipe and call” quickly.

Also as described in the exemplary embodiments, a group calling feature can be implemented in connection with one or more telephony applications and/or services that complement wireless telephony services provided by a mobile provider. Such a telephony application and/or service can be an alternative to the user using their mobile minutes.

If desired, the interface can display information such as icons informing the user of the identity of which participants in the group call are connected and/or on the call line. If desired, a user may remove a person from an ongoing group call by “swiping” the person out of the group list during a group call. A person can be removed from the group list in a similar manner before a group call is established.

It is understood that any steps, logical functions, or features as disclosed herein can be implemented in different combinations (e.g., can be implemented by omitting step(s) or function(s)) or can be implemented in an order or sequence different from any order or sequence described herein. It will also be apparent to those skilled in the art that any storage devices utilized to provide computer-readable and computer-executable instructions and data can be distributed over a network using a non-transitory computer-readable medium.

It is to be understood that the presently disclosed invention is not to be limited to the exact configurations as illustrated and described herein. To those of ordinary skill in the art, one or more inventions will be understood to be contemplated from the present application. Accordingly, all expedient modifications readily attainable by one of ordinary skill in the art from the disclosure set forth herein, or by routine experimentation there from, are deemed to be within the spirit and scope of the invention as defined by the appended claims.

What is claimed is:

1. A method for managing group calling from a wireless mobile application, comprising:
providing one or more wireless mobile devices that access a wireless network;
enabling at least one user to create at least one group call using one of the mobile devices;
using swipe gestures to create groups from a user's contact list; and
establishing the at least one group call over the wireless network.

2. The method of claim 1, wherein the swipe gestures include one or more of finger gestures, optical gestures, voice commands and equivalents and combinations thereof.

3. The method of claim 2, further including providing a network interface for performing at least one of:
communicating with other mobile devices over the network;
creating a group list from a contact list, with the group list including one or more participants from the contact list and with each participant having an associated mobile number;
notifying participants of a group call schedule; and
managing a group call;
wherein the at least one user uses swipe gestures to create the group list from the contact list; and
wherein the at least one user uses swipe gestures to manage the group call.

4. The method of claim 3, wherein managing the group call includes at least one of:
moving participants between the contact list and the group list to create at least one call group for the group call;
viewing participants in the at least one call group;
establishing the group call from the interface to simultaneously call all participants in the call group; and
terminating the group call from the interface for at least one participant in the call group.

5. The method of claim 4, wherein the contact list includes at least two participants.

6. The method of claim 4, further including saving the group list into the contact list.

7. The method of claim 4, wherein establishing the group call passes the group list to a server in electrical communication with the network for creation of a group call number.

8. The method of claim 7, wherein the server communicates the status of each participant of the group call to the interface for viewing on a mobile device display.

9. The method of claim 8, wherein the at least one user uses swipe actions to communicate to the server actions including one or more of adding a new group call participant, hanging up on a group call participant, changing audio and visual properties for the group call and monitoring a group call duration.

10. The method of claim 2, wherein the creating a group list creates a table view of new call groups to associate the swipe gestures to the construction of the group call list.

11. A system for managing group calling from a wireless mobile application, comprising:
one or more wireless mobile devices that access a wireless network;
wherein at least one mobile device includes a network interface for enabling a user to create at least one group call using swipe gestures to create groups from the user's contact list and to establish the at least one group call over the wireless network.

12. The system of claim 1, wherein the swipe gestures include one or more of finger gestures, optical gestures, voice commands and equivalents and combinations thereof.

13. The system of claim 12, wherein the network interface performs at least one of:
communicating with other mobile devices over the network;
creating a group list from a contact list, with the group list including one or more participants from the contact list and with each participant having an associated mobile number;
notifying participants of a group call schedule; and
managing a group call;
wherein the user uses swipe gestures to create the group list from the contact list; and
wherein the at least one user uses swipe gestures to manage the group call.

14. The system of claim 13, wherein managing the group call includes at least one of:
moving participants between the contact list and the group list to create at least one call group for the group call;
viewing participants in the at least one call group;
establishing the group call from the interface to simultaneously call all participants in the group list; and
terminating the group call from the interface for at least one participant.

15. The system of claim 14, further including a server in electrical communication with the network, wherein establishing the group call passes the group list to the server for creation of a group call number.

16. The system of claim 15, wherein the server communicates the status of each participant of the group call to the interface for viewing thereon by the user.

17. The system of claim 16, wherein the at least one user uses swipe actions to communicate to the server actions including one or more of adding a new group call participant, hanging up on a group call participant, changing audio and visual properties for the group call and monitoring a group call duration.

18. The system of claim 11, wherein the swipe gestures are used to construct the group list and create a table view of new call groups.

19. A method for managing group calling from a wireless mobile application, comprising:
providing a user interface on a mobile device;
establishing communications between a server and the user interface;
displaying a group calling component as part of the user interface;
receiving gesture commands that identify a group of individuals to be part of a group call initiated by the user of the mobile device, wherein the gesture commands involve moving group members into a designated space for making group calls; and
receiving an indicator by the user to make the group call.

20. A system for managing group calling from a wireless mobile application, comprising:
at least one mobile device provided with a user interface in communication with a server;
wherein the network interface performs at least one of:
displaying a group calling component as part of the user interface;
receiving gesture commands that identify a group of individuals to be part of a group call initiated by a user of the mobile device, wherein the gesture commands involve moving group members into a designated space for making group calls; and
receiving an indicator by the user to make the group call.
